(19) United States
(12) Patent Application Publication
(10) Pub. No.: US 2009/0138370 A1
(43) Pub. Date: May 28, 2009

(54) Methods and Systems for Controlling the Replay of Contents Stored in a Recording Medium

(76) Inventors: Hirohito KITATORA, Tokyo (JP); Heihachiro NISHIMURA, Tokyo (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/269,424

(22) Filed: Nov. 12, 2008

(30) Foreign Application Priority Data
Nov. 14, 2007 (JP) 2007-295843

(51) Int. Cl. G06Q 30/00; G06Q 50/00

(52) U.S. Cl. 705/26; 705/34

(57) ABSTRACT

Upon receipt of a replay request for a content to be replayed from a video replay apparatus, a content replay control system searches a content information storage for billing information corresponding to a content ID included in the replay request, searches a user information storage for a URL corresponding to a video replay apparatus ID included in the replay request, associates the retrieved billing information with the retrieved URL, and stores the associated information. The content replay control system maintains the connection with the video replay apparatus. Upon acceptance of the request for access to a URL from a portable terminal, the content replay control system reads the billing information stored in association with the URL and transmits the read billing information to the portable terminal. Upon receipt of a request for purchasing the content to be replayed from the portable terminal, the content replay control system identifies a billing server on the basis of a portable terminal ID of the portable terminal and transmits a billing request based on the read billing information to the billing server. Then, the content replay control system transmits release information for releasing a replay restriction to the video replay apparatus, the connection with which has been maintained, on condition that the billing on the content to be replayed has been completed.

### BACKGROUND OF THE INVENTION

1. Field of the Invention

The present invention relates to a technique for controlling the replay of a content stored in a recording medium, such as an optical disc, and more particularly, to a technique for controlling the replay of contents provided beforehand with a restriction on the replay by a user.

2. Description of the Related Art

An optical disc, which is a currently dominating large-capacity recording medium, is used to record content data, such as a computer program or a movie. An example of such an optical disc is a digital versatile disk (DVD). A DVD-ROM is a replay-only disc having DVD-Video or DVD-Audio specified as the application format therefor. The DVD-Video, which is a video format specified for recording contents, allows control information for implementing a function for restricting the replay by a user (a replay restriction function) to be recorded in addition to contents data.

A media supplier who provides their users with DVD media controls the replay of contents by utilizing the aforesaid control information of the DVD-Video. As an example of the content replay control, there has been known a method whereby the preview of a movie, which has been recorded in a DVD medium, is set free of charge whereas a certain amount of charge is set for viewing the full movie.

The replay of the movie content for which a viewing charge has been set is controlled by, for example, the method described below. A movie content is locked by a media supplier beforehand and supplied to a user in a state in which the movie content can be unlocked using a particular key.

When a user operates the remote controller of a DVD player to issue a request for replaying the movie content, the DVD player displays a predetermined number on the screen. The user checks the predetermined number displayed on the screen of the DVD player and operates his/her cellular phone to access the website of the media supplier and enters the predetermined number. Then, according to the instructions given on the website, the user pays the charge by, for example, entering the number of his/her credit card through the cellular phone. In response, a code number is sent from the website of the media supplier to the cellular phone. The user then enters the code number displayed on the screen of the cellular phone in the DVD player by operating the remote controller of the DVD player. This causes the DVD player to release the movie content according to the code number and starts replaying the movie content.

However, according to the aforesaid conventional control method for replaying contents, a user is required to take three steps as the procedure to replay the content, namely, (1) operating the remote controller of a DVD player to enter a request for replaying the content of a movie, (2) operating a cellular phone to enter a charge payment instruction, and (3) operating the remote controller of the DVD player again to enter a code number. Hence, the whole operation to be performed by a user to replay contents with the replay restrictions set thereon tends to be more complicated as compared with a case where contents with no replay restrictions set thereon are replayed (a case where contents are replayed when the remote controller is operated to enter the request for replaying the contents). This makes it difficult to spread the use of the contents with replay restriction features because of the lack of user-friendliness.

### SUMMARY OF THE INVENTION

An object of the present invention is to provide a new framework which permits ease of operation and convenience to users when the users try to replay contents with replay restriction features.

A system related to an embodiment of the present invention has a configuration which enables the system to communicate with a content replay apparatus and a portable terminal installed at a user's end so as to control the replay of contents with replay restrictions set thereon. The system is equipped with a user information storage means which stores a content replay apparatus ID specific to a content replay apparatus, a portable terminal ID specific to the portable terminal, and a predetermined URL, in association each other, and a content information storage means which stores a content ID specific to a content and the billing information on the content in association each other. Upon receipt of a replay request for a content to be replayed from the content replay apparatus, a billing information searching means searches the content information storage means for the billing information associated with the content ID included in the replay request for the content to be replayed, searches the user information storage means for the URL corresponding to the ID of the content replay apparatus included in the replay request for the content to be replayed, stores the retrieved billing information in association with the retrieved URL. A connection maintaining means maintains the connection with the content replay apparatus which has sent the replay request. Upon acceptance of a request for access to an URL stored in the user information storage means from the portable terminal, a billing information transmitting means reads out the billing information stored in association with the URL of the access request and transmits the read billing information to the portable terminal. Upon receipt of the purchase request for the content to be replayed from the portable terminal, the billing request means identifies the billing server of a carrier to which the portable terminal belongs on the basis of the portable terminal ID of the portable terminal, and transmits the billing request on the content to be replayed on the basis of the read billing information to the identified billing server. A release information transmitting means sends release information for releasing the replay restriction to the content replay apparatus, the connection of which has been maintained by the connection maintaining means and which has sent the replay request, on condition that the billing on the content to be replayed, for which the replay request has been issued, has been completed.

Preferably, the system is equipped with a recording means for recording a program executed on the content replay apparatus in the recording medium in which the content has been recorded. The program may include a module which, upon receipt of a URL sent from the content replay controlling system, displays the received URL on a screen, a module which, upon acceptance of a replay instruction for the content to be replayed from a user, generates a replay request for the content to be replayed, including a content replay apparatus ID of the content replay apparatus and transmits the generated replay request for the content to be replayed to the content replay control system, a module for maintaining the connection with the content replay control system, and a module for releasing the replay restriction on the content according to the release information transmitted from the content replay control system.

Preferably, the program may include a module for transmitting a dummy request for receiving a result of the processing carried out by the content replay control system according to the processing request transmitted from the portable terminal.

Preferably, upon the acceptance of the access request, the billing information transmitting means determines whether the URL of the access request and the portable terminal ID included in the access request have been associated and stored in the user information storage means. If it is determined that the URL of the access request and the portable terminal ID included in the access request have been associated and stored in the user information storage means, then the billing information stored in association with the URL of the access request may be sent to the portable terminal.

Preferably, the system may be equipped with a content replay apparatus ID registering means which, upon receipt of a user registration request transmitted from the content replay apparatus, generates a URL uniquely corresponding to the content replay apparatus ID included in the user registration request, stores the generated URL in association with the content replay apparatus ID in the user information storage means, and sends the generated URL to the content replay apparatus, and a portable terminal ID registering means which, upon receipt of a request for access to a URL stored in the user information storage means from the portable terminal, stores the portable terminal ID included in the access request in association with the URL of the access request in the user information storage means if the portable terminal has not yet been registered.

Preferably, the content on which the replay restriction has been set is a content which has been encoded according to a predetermined method, and the release information transmitting means may send the information for decoding the encoded content as the release information for releasing the replay restriction of the content.

Preferably, if the content replay apparatus transmits a dummy request, the billing information transmitting means may send the read billing information to the content replay apparatus as a response to the dummy request.

Another embodiment of the present invention is a method for controlling the replay of contents recorded in a recording medium replayed by a content replay apparatus. A server configured to be capable of communicating with the content replay apparatus and a portable terminal installed at a user's end has a content information storage means which stores a content ID specific to the contents in association with the billing information on the content, and a user information storage means which stores a content replay apparatus ID specific to a content replay apparatus, a portable terminal ID specific to a portable terminal, and a predetermined URL in association with each other. Upon receipt of a replay request for content to be replayed from the content replay apparatus, the server searches the content information storage means for the billing information associated with the content ID included in the replay request for the content to be replayed, searches the user information storage means for the URL corresponding to the content replay apparatus ID included in the replay request for the content to be replayed, then stores the retrieved billing information in association with the retrieved URL. The server maintains the connection with the content replay apparatus which has transmitted the replay request. Upon acceptance of a request for access to an URL stored in the user information storage means from the portable terminal, the server reads the billing information stored in association with the URL of the access request and transmits the read billing information to the portable terminal. Upon receipt of the purchase request for the contents to be replayed from the portable terminal, the server identifies the billing server of a carrier to which the portable terminal belongs on the basis of the portable terminal ID of the portable terminal, and transmits the billing request on the content to be replayed on the basis of the read billing information to the identified billing server. The server transmits release information for releasing the replay restriction to the content replay apparatus, the connection of which has been maintained by the connection maintaining means and which has sent the replay request, on condition that the billing on the content to be replayed, for which the replay request has been issued, has been completed.

Another embodiment of the present invention is a method for controlling the replay of a content by using a content replay control system equipped with a content replay apparatus, a portable terminal, and a server. Upon acceptance of a replay instruction for a content to be replayed from a user, the content replay apparatus generates a replay request for the content to be replayed from a user, the content replay apparatus generates a replay request for the content to be replayed, including a video replay apparatus ID of the content replay apparatus, and transmits the generated replay request for the content to be replayed to the server. Upon receipt of the replay request of the content to be replayed from the content replay apparatus, the server searches the content information storage means, which stores a content ID specific to the contents and the billing information on the content in association with each other, for the billing information associated with the content ID included in the replay request for the content to be replayed, searches the user information storage means, which stores the content replay apparatus ID specific to the content replay apparatus, the portable terminal ID specific to the portable terminal, and a predetermined URL, in association with each other, for the URL corresponding to the content replay apparatus ID included in the replay request for the content to be replayed, then stores the retrieved billing information in association with the retrieved URL. The content replay apparatus and the server maintain the connection therebetween. Upon acceptance of an instruction for access to an URL stored in the user information storage means from a user, the portable terminal generates a request for access to the URL, which includes the portable terminal ID of the portable terminal, and transmits the generated request for access to the URL to the server. Upon receipt of a request for access to the URL transmitted from the portable terminal, the server transmits the billing information stored in association with the URL of the access request to the portable terminal. Upon acceptance of a purchase request for the content to be replayed from a user, the portable terminal generates a request for purchasing the content to be replayed and transmits the generated request for purchasing the content to be replayed to the server. Upon receipt of the request for purchasing the content to be replayed transmitted from the portable terminal, the server identifies the billing server of a carrier to which the portable terminal belongs on the basis of the portable terminal ID of the portable terminal, and transmits the billing request on the content to be replayed on the basis of the billing information to the identified billing server. The server transmits release information for releasing the replay restriction to the content replay apparatus, the connection of which has been maintained and which has sent the replay request, on condition that the billing on the content to be replayed, for which the replay request has been issued, has been completed.

Another embodiment of the present invention is a recording medium in which a content with a replay restriction set thereon and a program for controlling the operation of a content replay apparatus which replays the content have been recorded. The program includes a module which displays, on a screen, a URL received from a predetermined computer, a module which generates, upon receipt of an instruction for replaying the content with the replay restriction set thereon from a user, a content replay request which includes the ID of a content replay apparatus and transmits the generated content replay request to the predetermined computer, a module which maintains connection with the predetermined computer, and a module which transmits a dummy request for receiving a result of the processing carried out by the predetermined computer according to the processing request transmitted from the portable terminal, and a module which releases the replay restriction set on the content according to the release information for releasing the replay restriction transmitted from the predetermined computer as the response to the transmitted dummy request.

The steps to be implemented by a server or the steps to be implemented by a video replay apparatus in the method for controlling the replay of contents can be executed by a CPU functioning as a controller in the server or the video replay apparatus according to a program. The program may be downloaded through the intermediary of various types of recording media, such as a CD-ROM, a magnetic disk or a semiconductor memory, or through the intermediary of a communication network and then installed in or loaded to the server or the video replay apparatus.

The term “means” used in the present specification does not merely mean a physical means, but also includes cases where the functions of the means are implemented by software. Further, a function of a single means may be implemented by two or more physical means or the functions of two or more means may be implemented by a single physical means.

### BRIEF DESCRIPTION OF THE DRAWINGS

FIG. 1 is a block diagram schematically illustrating the configuration of a content replay control system 1;

FIG. 2A is a block diagram illustrating the hardware configuration of a replay control server 2;

FIG. 2B is a block diagram illustrating the functional configuration of the replay control server 2;

FIG. 3 is an explanatory diagram illustrating the data structure of each storage means of storage means 21;

FIG. 4 is a diagram illustrating the data configuration of a DVD medium M;

FIG. 5A is a block diagram illustrating the hardware configuration of a video replay apparatus 4;

FIG. 5B is a block diagram illustrating the functional configuration of the video replay apparatus 4;

FIG. 6 is a flowchart for explaining the operation performed by the content replay control system 4;

FIG. 7 is another flowchart for explaining the operation performed by the content replay control system 1;

FIG. 8 is still another a flowchart for explaining the operation performed by the content replay control system 1;

FIG. 9 is another flowchart for explaining the operation performed by the content replay control system 1;

FIG. 10 is yet another flowchart for explaining the operation performed by the content replay control system 1;

FIG. 11 is an explanatory diagram illustrating screens displayed by the content replay control system 1; and

FIG. 12 is another explanatory diagram illustrating screens displayed by the content replay control system 1.

### DETAILED DESCRIPTION

The following will describe the construction and operation of an embodiment of the present invention with reference to the accompanying drawings.

### (1) Configuration of a Content Replay Control System According to the Present Embodiment

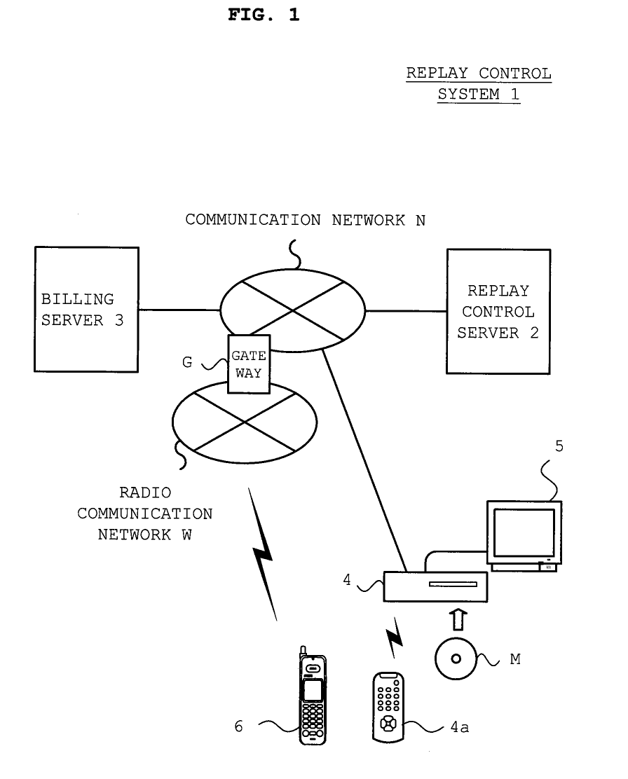

FIG. 1 is a block diagram schematically illustrating the configuration of a content replay control system according to the present embodiment. A content replay control system 1 has a DVD medium M, a replay control server 2, a billing server 3, a video replay apparatus 4, and a portable terminal 6. In the present embodiment, a case where the replaying or viewing of a video content recorded in a DVD is controlled will be described as an example of the replay control of a content recorded in a recording medium, such as an optical disc.

The replay control server 2 is installed at a media supplier who distributes or supplies the DVD medium M to a viewer or user. The billing server 3 is installed at a carrier to which the portable terminal 6 of the user belongs. The video replay apparatus 4 and the portable terminal 6 are installed at the user who has purchased the DVD medium M. The replay control server 2, the billing server 3, the video replay apparatus 4, and the portable terminal 6 are connected through a communication network N so as to permit mutual communication. Although FIG. 1 shows only one of each of the replay control server 2, the billing server 3, the video replay apparatus 4, and the portable terminal 6, more than one of each of them may be provided as necessary according to a configuration design.

The content replay control system 1 which performs communication through the intermediary of the communication network N may be configured using a conventional technique of a Website Application Server system. More specifically, the replay control server 2 functions as a web server, an application (AP) server, and a database server. When the replay control server 2 accepts a predetermined request transmitted according to, for example, the HTTP protocol, from the video replay apparatus 4 or the portable terminal 6 functioning as a client, the replay control server 2 carries out processing according to the predetermined request and then transmits the result of the processing to the video replay apparatus 4 or the portable terminal 6.

The video replay apparatus 4, which corresponds to a content replay apparatus, is typically represented by an optical disc replay apparatus (e.g., a DVD player in this case) which can be connected to the communication network N. A remote controller 4a as a user interface and a display device 5 outputting the stream data, which has been reproduced by the video replay apparatus 4, in the form of video and audio signals are attached to the video replay apparatus 4.

A portable telephone, a PHS, a smart phone or the like capable of wireless communication may typically be used as the portable terminal 6; however, another type of device may be applied. The portable terminal 6 is provided with an Internet connection feature in addition to a standard wireless telephone feature. The portable terminal 6 transmits a predetermined request conforming to, for example, the HTTP protocol, to a node (e.g., a replay control server 2) on the Internet through a gateway G from a radio communication network W. When a result in response to the request is received, the portable terminal 6 displays the received result.

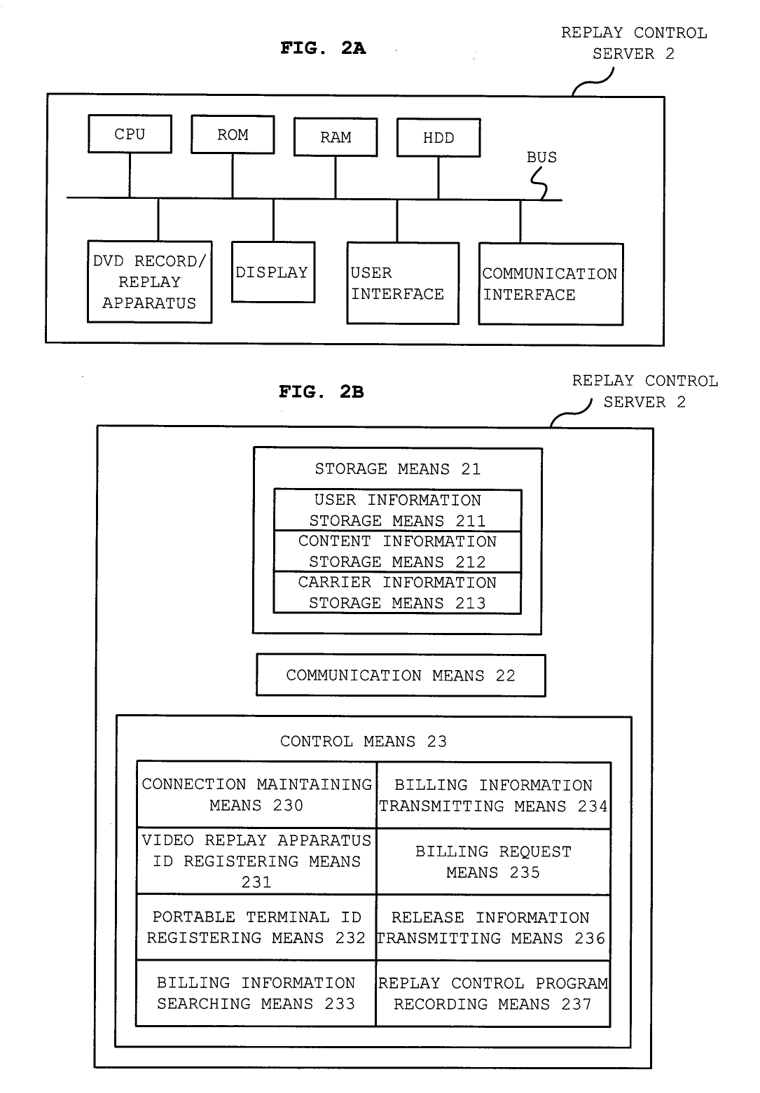

FIG. 2A is a block diagram illustrating the hardware configuration of the replay control server 2. As illustrated in FIG. 2A, the replay control server 2 may be constructed of a general-purpose computer provided with hardware, including a CPU, a ROM, a RAM, an HDD, a communication interface, a user interface, a display, and a recording/replaying device of a recording medium, such as a DVD.

FIG. 2B is a block diagram illustrating the functional configuration of the replay control server 2. As illustrated in FIG. 2B, the replay control server 2 includes functional means (functional units), such as a storage means (a memory unit) 21, a communication means (a communication unit) 22, and a control means (a control unit) 23. The storage means 21 includes a plurality of storage means (memory units), such as a user information storage means 211, a content information storage means 212, and a carrier information storage means 213.

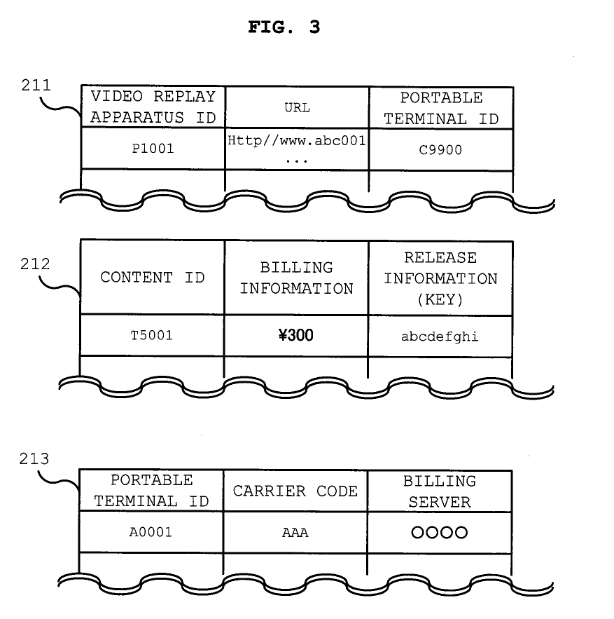

FIG. 3 illustrates some examples of the data structures of the individual storage means illustrated in FIG. 2B. These data structures can be created using a conventional database technique, such as a relational database technique. The ones given in FIG. 3 are, however, mere examples, and other structures or data structures or the like may be adopted. The user information storage means 211 associates, for example, a video replay apparatus ID for uniquely identifying the video replay apparatus 4 of a user, a URL to which the user is prompted to access at the time of user registration or content billing, and a portable terminal ID for uniquely identifying the portable terminal 6 of the user, and then stores all the associated information. The content information storage means 212 associates, for example, a content ID for identifying the content, the billing information on the content, and the information for releasing the viewing restriction placed on the content (hereinafter referred to as “the release information”), then stores all the associated information. As the release information, a cryptographic key for decoding an encoded content for example, may be stored. The carrier information storage means 213 associates a portable terminal ID, the code of the carrier to which the portable terminal belongs, and the information on the billing server of the carrier, and then stores all the associated information.

Returning to FIG. 2, the communication means 22 is configured to permit the input/output of information between itself and the billing server 3, the video replay apparatus 4, the portable terminal 6, and the like through the communication network N. The communication means 22 is equipped with a communication module, such as a PPP driver, a TCP/IP driver or the like.

The control means 23 controls the operation of the entire replay control server 2. More specifically, the control means 23 is equipped mainly with a connection maintaining means 230, a video replay apparatus ID registering means 231, a portable terminal ID registering means 232, a billing information searching means 233, a billing information transmitting means 234, a billing request means 235, a release information transmitting means 236, and a replay control program recording means 237.

The connection maintaining means 230 maintains the connection (session) established between the replay control server 2 and the video replay apparatus 4 and the connection (session) established between the replay control server 2 and the portable terminal 6 according to a predetermined requirement. The predetermined requirement may be set such that the connection is maintained while the viewing control processing related to the present invention is being carried out, e.g., until the viewing restriction on the content to be viewed is released after the video replay apparatus 4 transmits a replay request for the content to be viewed. For such a connection maintaining feature, the KeepAlive feature of HTTP, for example, may be used. If a request for not releasing the connection (KeepAlive) is received from the video replay apparatus 4 or the portable terminal 6, then the connection maintaining means 230 maintains the connection even after single response processing is finished. When a request for releasing the connection is accepted from the video replay apparatus 4 or the portable terminal 6, the connecting maintaining means 230 releases the connection.

The video replay apparatus ID registering means 231 registers, as user information, the information on the video replay apparatus 4 with which the user views the content. More specifically, upon acceptance of a user registration request from the video replay apparatus 4, the video replay apparatus ID registering means 231 generates a URL uniquely associated with the video replay apparatus ID included in the user registration request (hereinafter referred to as “URL (X)”) and associates the generated URL (X) with the video replay apparatus ID, then stores the associated information in the user information storage means 211. The generated URL (X) is also transmitted to the video replay apparatus 4.

The portable terminal ID registering means 232 registers, as user information, the information on the portable terminal 6 used by the user to pay the viewing bill of the content. More specifically, upon receipt of the request for access to the URL (X) from the portable terminal 6, the portable terminal ID registering means 232 associates the portable terminal ID included in the request for access to the URL (X) with the URL (X) and stores the associated information in the user information storage means 211. According to the video replay apparatus ID registering means 231 and the portable terminal ID registering means 232, the video replay apparatus 4 which replays the content and the portable terminal 6 operated by the user are associated using the URL (X) as the key and then the associated information is stored. This arrangement implements the framework in accordance with the present invention for controlling the replay of a content in the video replay apparatus 4 by operating the portable terminal 6 when a content with a viewing restriction preset thereon is viewed on the video replay apparatus 4.

Upon acceptance of the request for replaying a content to be viewed which has been selected by the user as the one to be viewed (hereinafter referred to as “the to-be-viewed content”) from the video replay apparatus 4, the billing information searching means 233 determines whether billing has been set on the to-be-viewed content. More specifically, based on the content ID included in the to-be-viewed content replay request, the billing information searching means 233 searches the content information storage means 212 for the billing information, and if it is determined that billing has been set on the to-be-viewed content, then the billing information searching means 233 searches the user information storage means 212 for the URL corresponding to the video replay apparatus ID included in the to-be-viewed content replay request, and associates the retrieved billing information with the retrieved URL and then stores the associated information. Thus, the billing information (the viewing charge) of the to-be-viewed content is associated with the URL (X) accessed by the user through the portable terminal 6. Further, a message indicating that the to-be-viewed content is billed is transmitted to the video replay apparatus 4.

Upon acceptance of the request for access to the URL (X) from the portable terminal 6, the billing information transmitting means 234 reads the billing information stored in association with the URL (X) and transmits the read billing information to the portable terminal 6. Alternatively, the billing information transmitting means 234 may carry out user authentication before transmitting the billing information, and then transmit the billing information on the content according to the result of the authentication.

When the request for purchasing the to-be-viewed content is received from the portable terminal 6, the billing request means 235 searches the carrier information storage means 213 to identify the billing server of the carrier to which the portable terminal 6 belongs on the basis of the portable terminal ID of the portable terminal 6. Then, the billing request means 235 sends a billing request message, which requests for adding the viewing charge of the content to the phone bill of the portable terminal 6, to the identified billing server 3.

When the billing request means 235 receives a message, which indicates that the billing has been successfully terminated, from the billing server 3, the release information transmitting means 236 transmits release information (e.g., a cryptographic key) which enables replay of the content to the video replay apparatus 4 for which the connection maintaining means 230 is maintaining connection.

The replay control program recording means 237 records a program for restricting the viewing of a content recorded in the DVD medium M (hereinafter referred to as “the replay control program”) in a predetermined area of the DVD medium M. For this purpose, the replay control program recording means 237 has a feature for carrying out, for example, the authoring in a DVD medium manufacturing process.

FIG. 2B illustrates the aforesaid functions implemented in the control means 23 as functional means. In the following description, the aforesaid functions will be referred to as the functional means. The control means 23 also provides various other functions, such as a content downloading function, in addition to the functions described above.

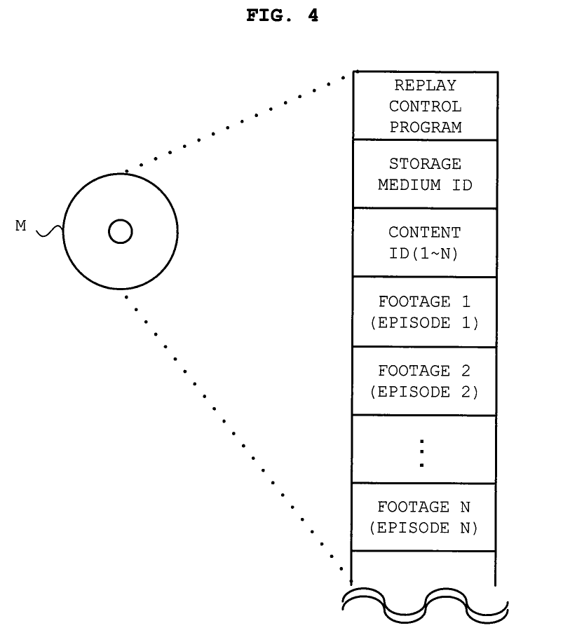

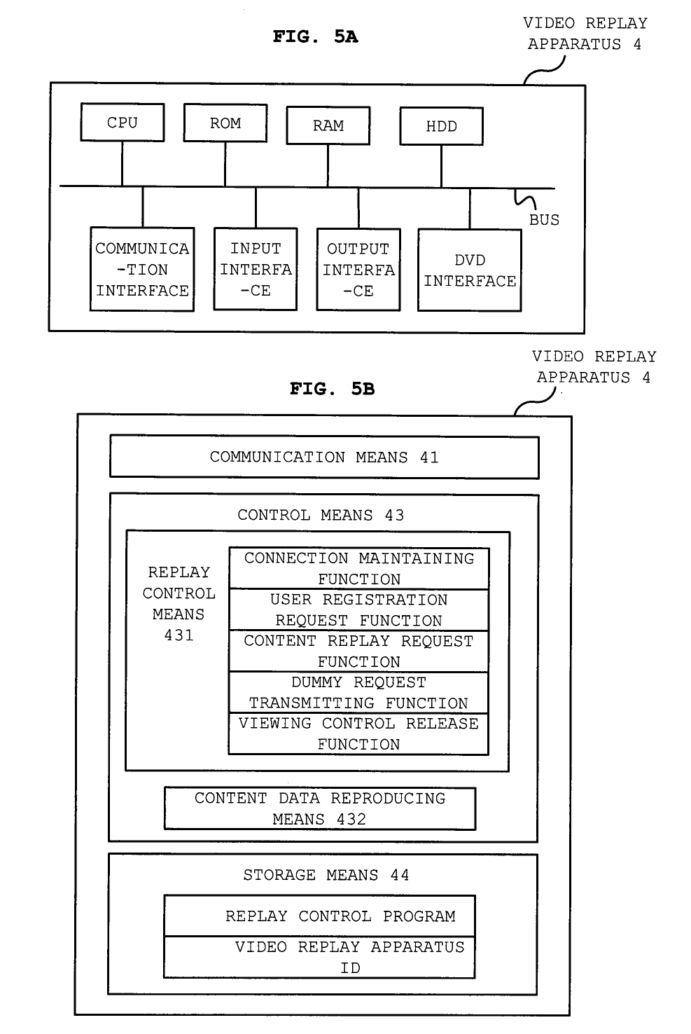

FIG. 4 illustrates the data structure of the DVD medium M replayed by the video replay apparatus 4 according to the DVD-Video specification. The DVD medium M contains a replay control program for controlling the replay of contents, a recording medium ID, a content ID (footage 1 to footage N), and the like in addition to the data of a content (footage 1 to footage N), the replay of which is controlled. The content data may include any data, such as audio data, still frame data, game applications, and PDF files in addition to video data. The replay control program is stored in a producing/manufacturing process to restrict the replay of the data of contents. For example, the replay control program recording means 237 of the replay control server 2 sets the replay control program such that direct replay of contents is disabled, while the replay of contents is enabled only if a predetermined requirement is met. The replay control program will be described in more detail later with reference to FIG. 5B.

FIG. 5A is a block diagram illustrating the hardware configuration of the video replay apparatus 4. As illustrated in FIG. 5A, the video replay apparatus 4 may be constituted of a general-purpose DVD player equipped with hardware, including a CPU, a ROM, a RAM, a HDD, a communication interface, an input interface, an output interface, and a DVD interface. The video replay apparatus 4 may alternatively be constructed of a general-purpose computer equipped with a DVD replay apparatus. The present invention covers a variety of recording media, including CDs, DVDs, Blu-ray Discs (BDs), and HDDVDs.

FIG. 5B is a block diagram illustrating the functional configuration of the video replay apparatus 4. As illustrated in FIG. 5B, the video replay apparatus 4 includes functional means, such as a communication means 41, a control means 43, and a storage means 44.

The communication means 41 is configured to permit the input/output of information, through the communication network N, between itself and the replay control server 2 and other devices connected to a network, and the communication means 41 is equipped with a communication module, such as a PPP driver, a TCP/IP driver or the like.

The control means 43 controls the operation of the entire video replay apparatus 4 and functions as a replay control means 431 and a content data reproducing means 432 according to a program stored in a RAM, an HDD, or the like.

The replay control means 431 functions when a replay control program (module) stored in the DVD medium M is executed by a CPU. The replay control program mainly includes a connection maintaining module, a user registration request module, a content replay request module, a dummy request transmission module, and a viewing control release module. The replay control means 431 mainly has a connection maintaining function, a user registration request function, a content replay request function, a dummy request transmission function, and a viewing control release function, which are implemented as the CPU executes the aforesaid modules. In the following description, these functions will be explained as the functions implemented by the replay control means 431; alternatively, however, each of the functions may be considered as a functional means.

The connection maintaining function maintains the connection (session) with the replay control server 2 according to a predetermined requirement by using, for example, the KeepAlive feature of HTTP. The replay control means 431 requires the connection with the replay control server 2 not be released (KeepAlive). If the predetermined requirement is met (e.g., if the viewing restriction on the to-be-viewed content has been cleared to replay the to-be-viewed content), then a connection release request is transmitted so as to release the connection.

When the DVD medium M is loaded on the video replay apparatus 4, the user registering function reads the video replay apparatus ID of the video replay apparatus 4 from the storage means 44, generates a user registration request which includes the read video replay apparatus ID, and sends the generated user registration request to the replay control server 2. The user registration is preferably completed before replaying the content.

Upon acceptance of the instruction for replaying the content from a user, the content replay request function generates a content replay request which includes the video replay apparatus ID of the video replay apparatus 4 and a content ID, and transmits the generated content replay request to the replay control server 2.

The dummy request transmitting function transmits, to the replay control server 2, a request for transmitting the result of the processing carried out by the replay control server 2 in response to a processing request transmitted from the portable terminal 6 (hereinafter referred to as “the dummy request”) to the video replay apparatus 4. The content replay control system 1 according to the present embodiment uses the configuration of a server/client system, so that the replay control server 2 cannot send, to the video replay apparatus 4, the processing result obtained in response to the processing request from the portable terminal 6 without a request from the video replay apparatus 4. Therefore, in the content replay control system in accordance with the present invention, the video replay apparatus 4 transmits a dummy request and the replay control server 2 transmits a processing result based on a processing request from the portable terminal 6 to the video replay apparatus 4 as the response to the dummy request. The video replay apparatus 4 preferably transmits a dummy request to enable the replay control server 2 to transmit a processing result to the video replay apparatus 4 in real time. For instance, the video replay apparatus 4 may be configured so as to transmit a dummy request upon receipt of a processing result from the replay control server 2 or to transmit a dummy request at predetermined intervals. With this arrangement, when a user sends a processing request to the replay control server 2 from the portable terminal 6, the replay control server 2 sends the result of processing to the video replay apparatus 4 as soon as the processing result is obtained, and the processing result is displayed on the video replay apparatus 4. This enables the user to use the portable terminal 6 as if it were an input interface for the video replay apparatus 4.

When the replay control server 2 sends the release information for releasing the viewing control on the content, the viewing control releasing function releases the viewing restriction on the content according to the release information. If the release information is, for example, a cryptographic key, then the cryptographic key is used to decode the content.

The functions provided in the replay control means 431 are not limited to those described above. Although not illustrated, the replay control means 431 is also equipped with a function for transmitting a predetermined request to the replay control server 2 according to the HTTP protocol in response to the operation by the user and for displaying a result in response to the request (e.g., webpage information including URL) upon receipt of the result, and a function for displaying a title menu and the like.

The content data replaying means 432 reads a content (stream data) from a DVD medium M, converts the read data into image data or the like, and then displays the converted data on the display 5.

The storage means 44 stores the replay control program loaded from the DVD medium M and executed by a CPU, and also stores the video replay apparatus ID of the video replay apparatus 4.

### (2) Processing by the Content Replay Control System According to the Present Embodiment

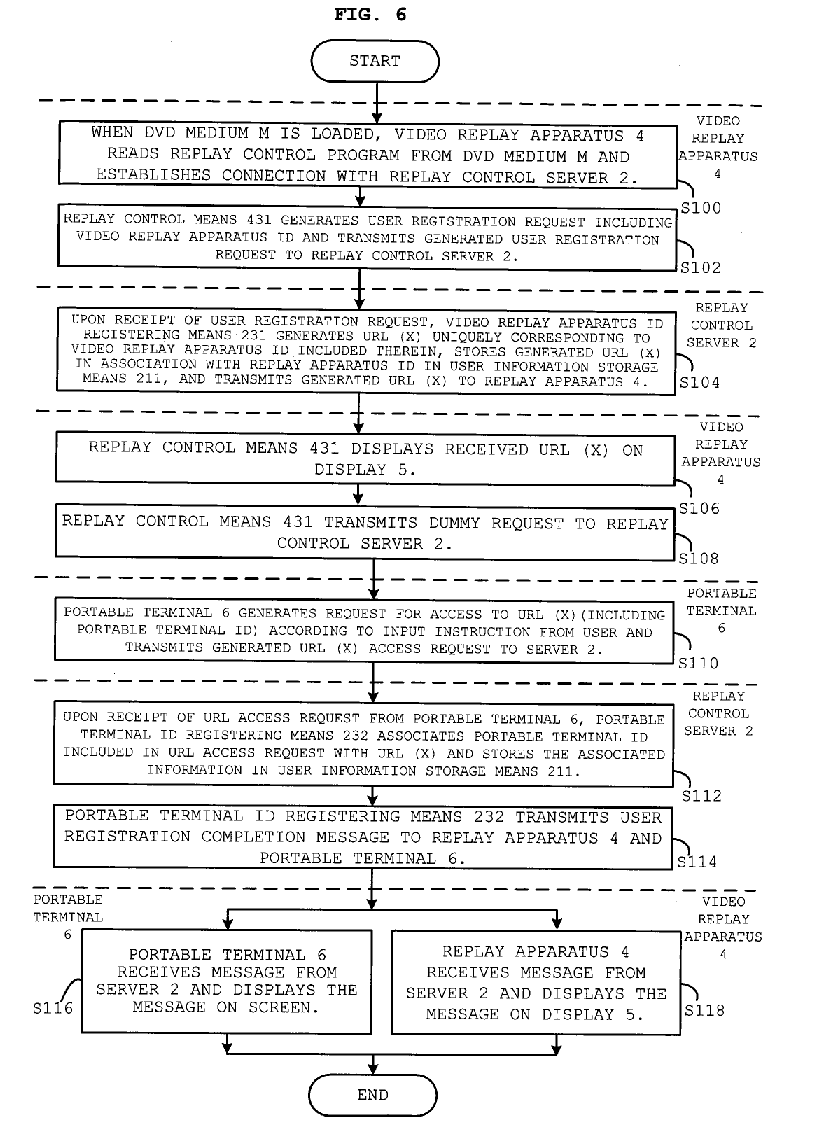

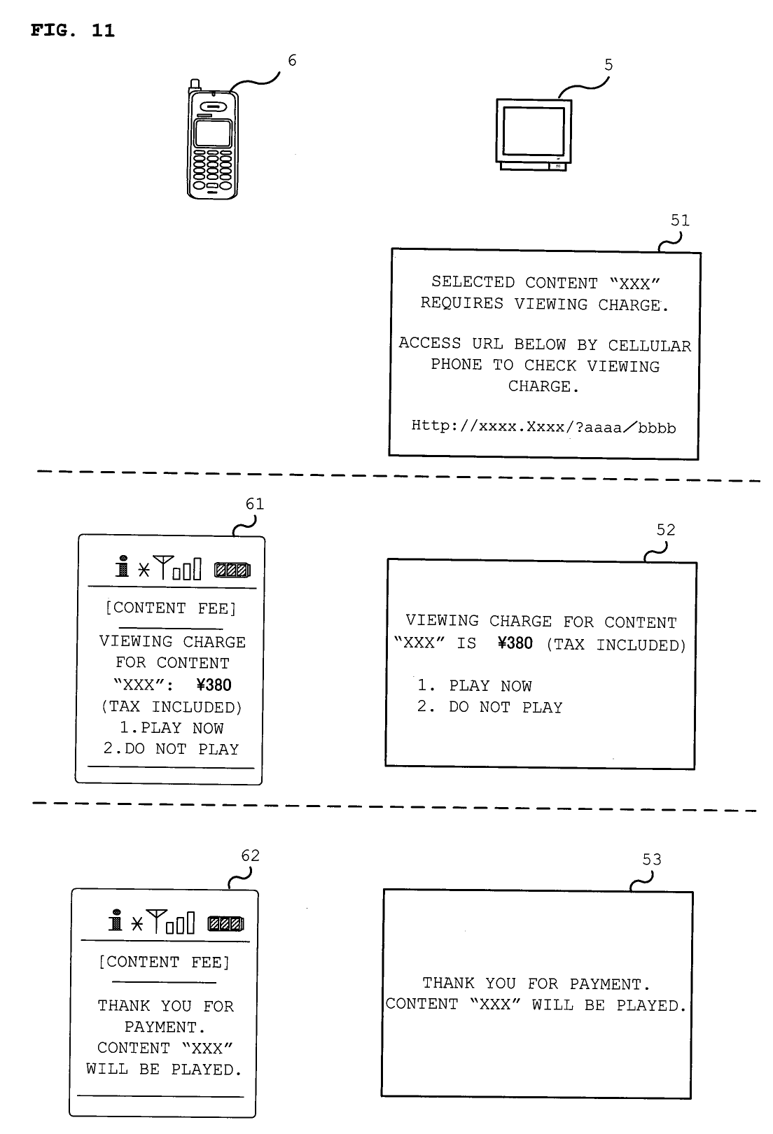

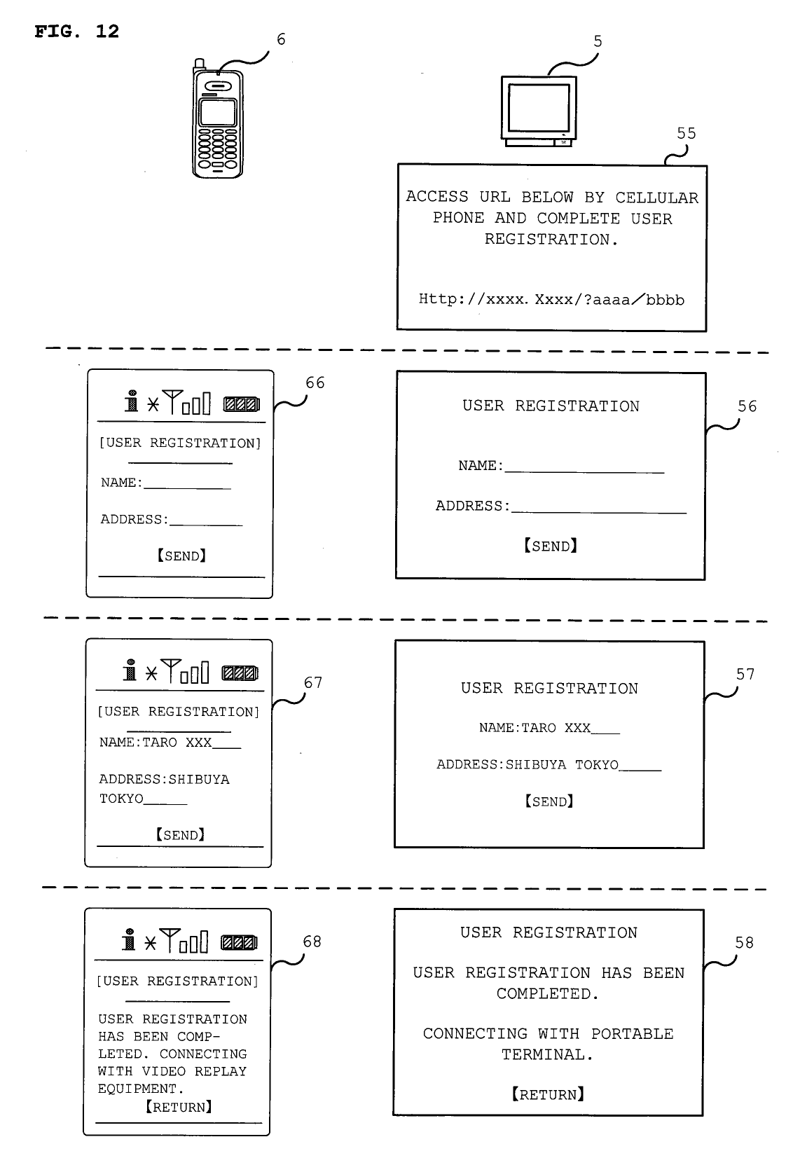

The following will describe a new framework implemented by the content replay control system 1 with reference to the flowcharts of FIG. 6 to FIG. 10 and the image constructions illustrated in FIG. 11 and FIG. 12. The order of carrying out the steps, including partial steps with no numeral reference assigned thereto, may be arbitrarily changed or the steps may be carried out in parallel as long as processing in the steps does not develop conflicts. In the flowcharts of FIG. 6 to FIG. 10, the video replay apparatus 4 is referred to as “the replay apparatus 4” and the replay control server 2 is referred to as “the server 2” in some places.

FIG. 6 is a flowchart illustrating an example of the processing carried out when a user loads the DVD medium M on the video replay apparatus 4. As soon as the DVD medium M is loaded, the CPU of the video replay apparatus 4 loads the replay control program recorded in the DVD medium M into a RAM and executes the program, thus implementing the function as the replay control means 431 (S100). The replay control means 431 establishes connection with the replay control server 2 according to, for example, the three-way handshake method (S102). When establishing the connection, the replay control means 431 sends the request for not to release the connection until a connection release request is received (KeepAlive) to the replay control server 2.

When the connection with the replay control server 2 is established, the replay control means 431 reads the video replay apparatus ID from the storage means 44, generates a user registration request which includes the read video replay apparatus ID, and sends the generated user registration request to the replay control server 2 (S102). The video replay apparatus ID is typically a serial number or the like given in the manufacturing process of the video replay apparatus 4, but not limited thereto. Any other information may be used as long as the information uniquely identifies the video replay apparatus 4.

Upon receipt of the user registration request, the video replay apparatus ID registering means 231 of the replay control server 2 extracts the video replay apparatus ID from the received user registration request, and generates a URL (URL (X)) which uniquely corresponds to the extracted video replay apparatus ID (S104). Subsequently, the video replay apparatus ID registering means 231 associates the generated URL (X) with the video replay apparatus ID and stores the associated information in the user information storage means 211, then sends the generated URL (X) to the video replay apparatus 4 (S104).

Upon receipt of the URL (X) from the replay control server 2, the replay control means 431 of the video replay apparatus 4 displays the received URL (X) on the display 5 (S106). Thus, the user acquires the information on the URL (X) to access in order to view a content and then enters the request for access to the displayed URL (X) by operating the portable terminal 6. The replay control means 431 transmits a dummy request to the replay control server 2 to prepare for inputs or the like from the portable terminal 6 (S108).

According to an input instruction of the user, the portable terminal 6 generates the request for access to the URL (X) which includes the portable terminal ID, and sends the generated request for access to the URL (X) to the replay control server 2 (S110).

Upon receipt of the request for access to the URL (X) from the portable terminal 6, the portable terminal ID registering means 232 of the replay control server 2 associates the portable terminal ID included in the received access request with the URL (X) and stores the associated information in the user information storage means 211 (S112). Further, the portable terminal ID registering means 232 transmits a message indicating that the user registration has been completed to the portable terminal 6 and also transmits the message to the video replay apparatus 4 as the response to a dummy request (S114).

Upon receipt of a message indicating the completion of the user registration, the portable terminal 6 and the video replay apparatus 4 display the message on the screen of the portable terminal 6 or the display 5 (S116 or S118). This completes the user registration processing. As the user information, the name or the like of the user may be registered in addition to the aforesaid information. The configuration for registering the name or the like of the user will be discussed later.

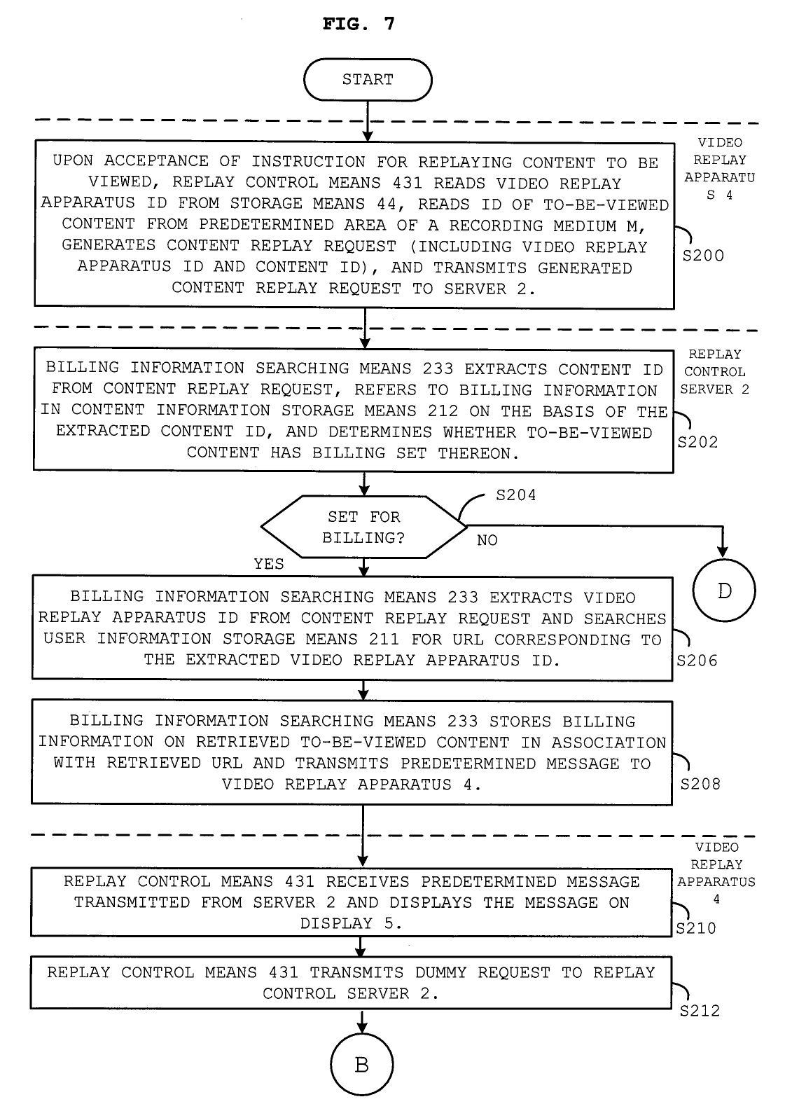

FIG. 7 is a flowchart illustrating an example of the processing carried out when the request for replaying the content selected by a user (to-be-viewed content) is input to the video replay apparatus 4. Upon acceptance of the instruction for replaying the to-be-viewed content from the user, the replay control means 431 transmits the request for replaying the to-be-viewed content to the replay control server 2 (S200). More specifically, the replay control means 431 reads the video replay apparatus ID from the storage means 44 and also reads the content ID of the to-be-viewed content from the DVD medium M, generates a request for replaying the content which includes the read information, namely, the video replay apparatus ID and the content ID, and transmits the generated request to the replay control server 2 (S200). The video replay apparatus 4 and the replay control server 2 remain in connection.

Upon receipt of the request for replaying the to-be-viewed content transmitted from the video replay apparatus 4, the billing information searching means 233 of the replay control server 2 checks whether the to-be-viewed content is charged. More specifically, the billing information searching means 233 extracts the content ID from the request for replaying the to-be-viewed content and searches the content information storage means 212 for the billing information associated with the content ID, then determines whether the to-be-viewed content have been set for billing (S202).

If it is determined that the to-be-viewed content has been set for billing (YES in S204), then the billing information searching means 233 extracts the video replay apparatus ID from the to-be-viewed content replay request and searches the user information storage means 211 for the URL associated with the extracted video replay apparatus ID (S206). Subsequently, the billing information retrieved in S202 is associated with the URL retrieved in S206, and the associated information is stored in a predetermined memory area (S208). Associating and storing information is typically represented by, for example, storing the link to retrieved billing information in the memory area indicated by a retrieved URL or by storing the screen information including the retrieved billing information in the memory area indicated by the retrieved URL. The billing information searching means 233 transmits a message, which prompts the user to pay the viewing charge of the content, to the video replay apparatus 4 (S208). The message may include the URL (X) to which the user should access. A case where no billing information for a particular to-be-viewed content is found in the content information storage means 212 (NO in S204) will be discussed later.

Upon receipt of the message transmitted from the replay control server 2, the replay control means 431 of the video replay apparatus 4 outputs the received message to the display 5 (S210). The replay control means 431 transmits a dummy request to the replay control server 2 to prepare for an input or the like from the portable terminal 6 (S212).

FIG. 11 illustrates an example screen displayed on the display 5 of the video replay apparatus 4. A screen 51 is displaying the message transmitted from the replay control server 2. Looking at the screen 51, the user recognizes that he/she has to pay a predetermined charge to view the content (e.g., Episode 3 of a certain drama) he/she has selected. The user operates his/her portable terminal 6 to access the URL (X) shown on the display 5.

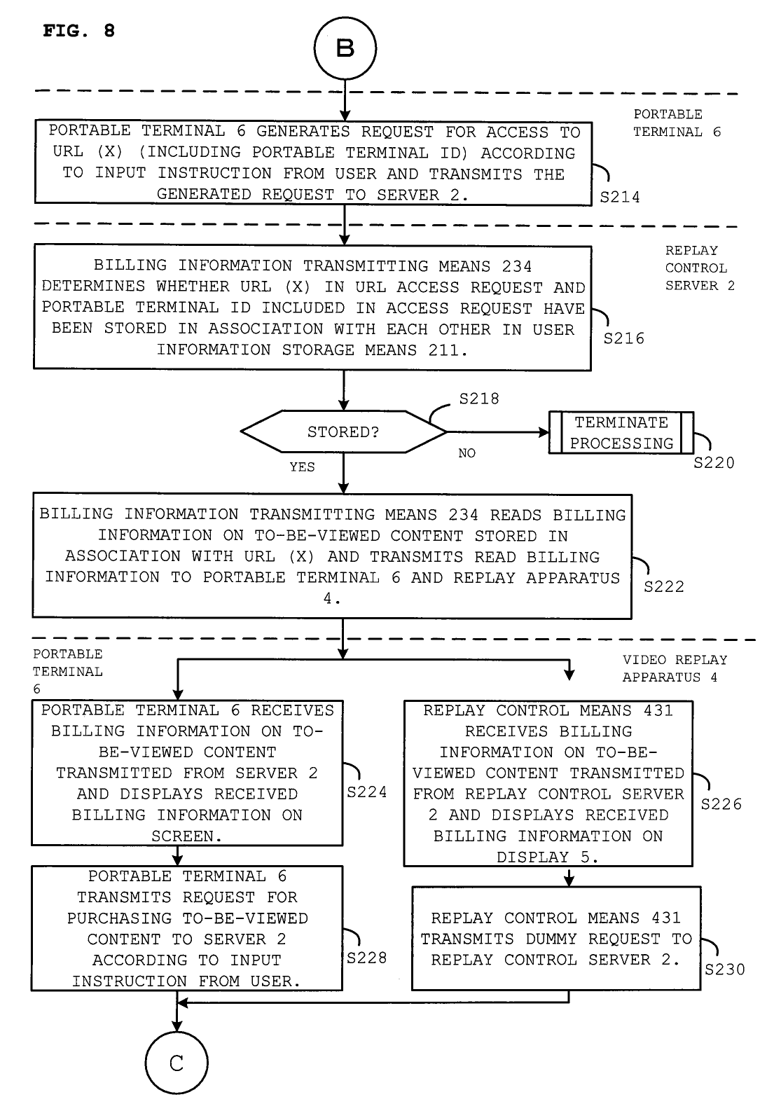

FIG. 8 is a flowchart illustrating an example of the processing carried out when the user sends the request for access to the URL (X) from the portable terminal 6. Upon receipt of the request for access to the URL (X) from the user, the portable terminal 6 generates an access request including the portable terminal ID which uniquely identifies the portable terminal 6 and transmits the generated access request to the replay control server 2 (S214).

The billing information transmitting means 234 of the replay control server 2 carries out user authentication upon receipt of the request for access to the URL (X). More specifically, it is determined whether the URL (X) for which the access is requested and the portable terminal ID included in the access request have been stored in association in the user information storage means 211 (S216). If it has been determined that the two pieces of information have been stored in association (YES in S218), then the billing information transmitting means 234 determines that the user is a registered user, and sends the billing information stored in association with the URL (X) to the portable terminal 6 as the viewing charge for the to-be-viewed content (S222). The billing information transmitting means 234 also sends the billing information on the to-be-viewed content to the video replay apparatus 4 as a response to the dummy request (S222). Meanwhile, if the two pieces of information have not been stored in association (NO in S218), then the billing information transmitting means 234 determines that the user is an unregistered user and terminates the processing without accepting the access request (S220).

Upon receipt of the billing information on the to-be-viewed content from the replay control server 2, the portable terminal 6 displays the billing information on the screen (S224) (refer to 61 of FIG. 11). The user may select “1. PLAY NOW” if he/she wishes to purchase the content, or select “2. DO NOT PLAY” if he/she does not wish to purchase the content. If the user selects to purchase the content (“1. PLAY NOW”), then the portable terminal 6 generates the request for purchasing the to-be-viewed content, which includes the portable terminal ID, and sends the generated request to the replay control server 2 (S134). If the user selects not to purchase the content (“2. DO NOT PLAY”), then the portable terminal 6 sends a non-purchase request for the content to the replay control server 2.

Meanwhile, upon receipt of the billing information on the to-be-viewed content transmitted from the replay control server 2, the replay control means 431 of the video replay apparatus 4 displays the received billing information on the display 5 (S226) (refer to 52 of FIG. 11). The display 5 of the video replay apparatus 4 displays the screen 51 and then the screen 52, enabling the user to feel as if he/she is using the portable terminal 6 were the input interface for the video replay apparatus 4. Upon receipt of the billing information from the replay control server 2, the replay control means 431 transmits the dummy request to the replay control server 2 to prepare for another input or the like from the portable terminal 6 (S230).

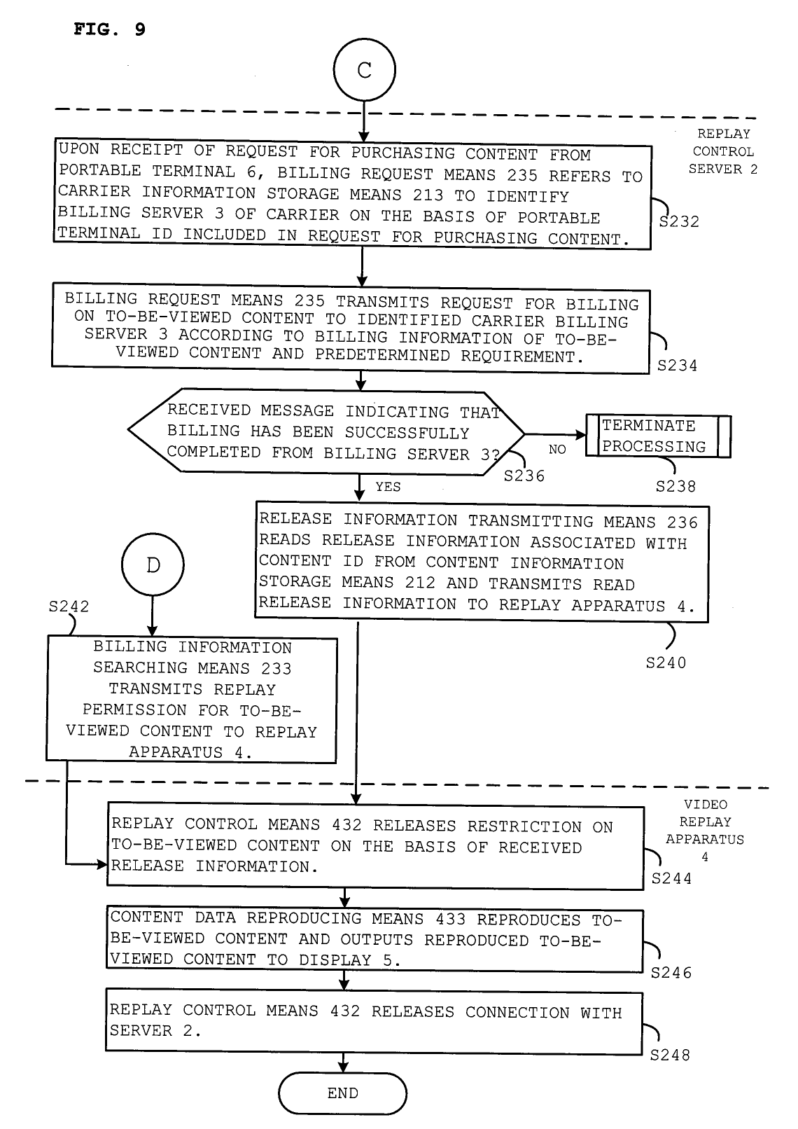

FIG. 9 is a flowchart illustrating an example of the processing carried out when the user selects to purchase the to-be-viewed content (“1. PLAY NOW”) at the portable terminal 6. Upon acceptance of the to-be-viewed content purchase request from the portable terminal 6, the billing request means 235 of the replay control server 2 identifies the billing server of the carrier to which the portable terminal 6 belongs (S232). More specifically, the billing request means 235 searches the carrier information storage means 213 to identify the billing server of the carrier corresponding to the portable terminal ID included in the to-be-viewed content purchase request (S232). The portable terminal ID is not limited to the one included in the to-be-viewed content purchase request; alternatively, the portable terminal ID may be included in a different access request transmitted from the portable terminal 6.

The billing request means 235 sends a billing request message requesting for billing the to-be-viewed content based on the billing information read by the billing information transmitting means to the billing server 3 of the identified carrier (S234). The request for billing the viewing charge is accomplished by sending the information which is prepared beforehand by, for example, the supplier of the DVD medium M who runs the replay control server 2 and the carrier who provides the user of the portable terminal 6 with communication service and which conforms to a predetermined requirement (e.g., a portable terminal ID, a telephone number, and the viewing charge of the to-be-viewed content) to the billing server 3 according to a predetermined procedure. Upon receipt of the billing request, the billing server 3 calculates the amount to be invoiced to the user by adding up the viewing charge of the content on the basis of the billing information transmitted from the replay control server 2 and the telephone charge of the portable terminal 6 (not illustrated).

The release information transmitting means 236 grants the replay of the content if the billing request means 235 receives the message indicating that the billing for the content has been successfully completed from the billing server 3 (YES in S236) (S240). More specifically, the release information transmitting means 236 reads the release information (e.g., a release key) corresponding to the content ID of the billed content from the content information storage means 212 and sends the read release information, as a response to the dummy request, to the video replay apparatus 4 of the user for which the connection maintaining means 230 is maintaining the connection (S240).

The release information transmitting means 236 terminates the processing without granting the replay of the content if the billing request means 235 receives a message indicating that the billing for the content has not been successfully accomplished from the billing server 3 (NO in S236) (S238). The processing may be terminated by, for example, notifying the video replay apparatus 4 to the effect that the billing for the content has not been successfully accomplished and then going back to a menu screen.

Upon receipt of the release information, the replay control means 431 of the video replay apparatus 4 releases the restriction on the content according to a predetermined method (S244). For example, the encoded content is decoded using a received release key. The content data reproducing means 432 reproduces the content data from which the restriction has been released, then outputs the reproduced content data to the display 5 (S246). The replay control means 431 sends the connection release request to the replay control server 2 (S248).

If it is determined in S204 that no viewing charge has been set for the content, then the billing information searching means 233 sends the replay permission for the content to the video replay apparatus 4 of the user (S242). Upon receipt of the replay permission for the content, the content data reproducing means 432 reproduces the content data and outputs the reproduced content data to the display 5 (S246).

Although not shown, the billing request means 235 may send a message indicating that billing has been successfully completed to the portable terminal 6 and the video replay apparatus 4 of the user, respectively, if billing request means 235 receives the message indicating that billing for the content has been successfully completed from the billing server 3 (YES in S236) (refer to 62 and 53 in FIG. 11). The display 5 of the video replay apparatus 4 displays the screen 52 and then the screen 53, enabling the user to feel as if he/she were using the portable terminal 6 as the input interface of the video replay apparatus 4.

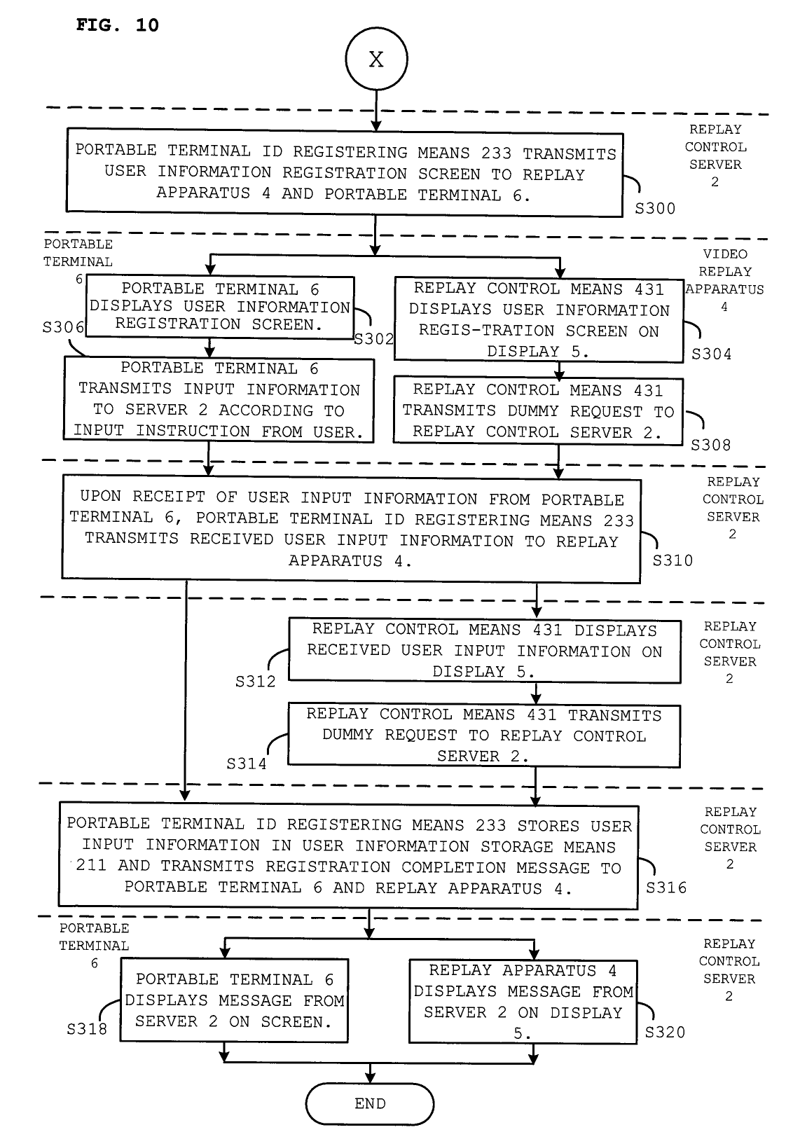

The processing for registering information, such as the name of the user, will now be described with reference to FIG. 10. The processing for registering the name of the user and the like may be added to the registration processing described in conjunction with FIG. 6.

The portable terminal ID registering means 232 associates the portable terminal ID and the URL and stores the associated information (S114 of FIG. 6), then transmits a user information registration screen for registering the name of the user and the like to the portable terminal 6 and the video replay apparatus 4, respectively (S300).

The portable terminal 6 and the video replay apparatus 4 respectively display the received user information registration screen (S302 and S304) (refer to a screen 66 and a screen 56 of FIG. 12). The replay control means 431 of the video replay apparatus 4 sends the dummy request to the replay control server 2 to prepare for an input or the like from the portable terminal 6 (S308). The user operates the portable terminal 6 to enter information, such as his/her name and address. Upon acceptance of an input instruction from the user, the portable terminal 6 sends the entered information to the replay control server 2 (S306) (refer to a screen 67 of FIG. 12).

Upon receipt of the user input information from the portable terminal 6, the portable terminal ID registering means 232 of the replay control server 2 sends the user input information to the video replay apparatus 4 as the response to the dummy request (S310). The replay control means 431 of the video replay apparatus 4 displays the received user input information on the display 5 (S312) (refer to a screen 57 of FIG. 12). The replay control means 431 sends the dummy request to the replay control server 2 to prepare for an input or the like from the portable terminal 6 (S314).

The portable terminal ID registering means 232 associates the user input information from the portable terminal 6 with the portable terminal ID and stores the associated information in a predetermined area (not shown) of the user information storage means 211, then sends the message indicating the completion of the registration to the portable terminal 6 and the video replay apparatus 4, respectively (S316).

The portable terminal 6 displays the received message indicating the completion of the registration on the screen (S318) (refer to a screen 68 of FIG. 12). The replay control means 431 of the video replay apparatus 4 also displays the received message indicating the completion of the registration on the display 5 (S320) (refer to a screen 58 of FIG. 12). According to the user registration processing described above, the display 5 of the video replay apparatus 4 displays the screens 56 to 58 following the screen 55, enabling the user to feel as if he/she were using the portable terminal 6 as the input interface for the video replay apparatus 4.

The present embodiment makes it possible to provide a new framework useful for replaying a content provided with a restriction on the replay thereof on a predetermined video replay apparatus. The framework permits the payment for a content and the release of the content to be accomplished by operating a portable terminal.

Furthermore, according to the present embodiment, when a user, who issues the request for replaying a content for which a viewing charge has been set, enters an instruction for paying the viewing charge through the portable terminal 6, the billing processing is automatically carried out and the viewing restriction on the content in the video replay apparatus 4 is released. This arrangement enables the user to carry out two types of processing, namely, the paying the viewing charge for the content and releasing the viewing restriction on the content, by a single input operation on the portable terminal 6 and also enables the user to use the portable terminal 6 as if it were the input interface of the video replay apparatus 4.

Further, according to the present embodiment, the video replay apparatus 4 sends a dummy request to prepare for an input or the like from the portable terminal 6, the result of a processing request instructed by the user through the portable terminal 6 is sent to the video replay apparatus 4 and displayed in real time. This allows the portable terminal 6 to function like the input interface of the video replay apparatus 4.

Further, according to the present embodiment, the viewing charge of a content is billed by adding the viewing charge to the telephone charge of the portable terminal 6. Hence, the user is required simply to enter the payment instruction for the viewing charge through the portable terminal 6, obviating the need for separately entering the information on his/her credit card or the like.

Further, according to the present embodiment, the connection between the replay control server 2 and the video replay apparatus 4 is maintained, thus making it possible to avoid the disconnection due to time-out when, for example, response processing in the replay control server 2 takes time or the processing requested by the portable terminal 6 takes time.

Further, according to the present embodiment, the replay control program which defines the operation of the video replay apparatus 4 is stored beforehand in the DVD medium M, which is distributed, thus allowing the viewing control on the contents to be accomplished without the need for incorporating a new system in an existing video replay apparatus.

### (3) Other Embodiments

The present invention is not limited to the aforesaid embodiment and can be applied to various modifications. For example, the video contents of the DVD-Video have been used in the aforesaid; however, the present invention is also applicable to a case where video contents of other than the DVD-Video are prepared.

In the aforesaid embodiment, the DVD has been taken as an example of a recording medium in which contents have been recorded; however, the recording media to which the present invention is applied are not limited to DVDs. The present invention can be similarly applied also to, for example, optical discs, such as Blu-ray Discs and HDDVDs.

In the aforesaid embodiment, the replay of a video content has been taken as an example of the content replay control; however, the present invention is not limited thereto. The replay of contents in accordance with the present invention may include, for example, the output of voices, the display of still images, the execution of a game application, and the display of a PDF file.

In the aforesaid embodiment, the replay control program for causing the video replay apparatus 4 to function as the replay control means 431 is stored in the DVD medium M; alternatively, however, the replay control program may be downloaded through the communication network N and installed or loaded in the video replay apparatus 4. Further alternatively, the replay control program may be acquired by being embedded in web page information when a predetermined site in the replay control server 2 is accessed by the replay control means 431 to acquire the web page information.

In the aforesaid embodiment, the configuration for maintaining the connection between the relay control server 2 and the video replay apparatus 4 until the connection release request is transmitted has been described; however, the configuration for maintaining the connection is not limited thereto. For instance, the connection may be maintained by setting the video replay apparatus 4 and the portable terminal 6 such that a predetermined request is transmitted as soon as a response result (response) is received.

The aforesaid embodiment has described the configuration whereby the video replay apparatus 6 transmits a dummy request to the replay control server 2, and the replay control server 2 transmits the result of processing carried out in response to a request from the portable terminal 6 or information entered through the portable terminal 6 to the video replay apparatus 6. As an alternative configuration, the portable terminal 6 may transmit the dummy request to the replay control server 2, and the replay control server 2 may transmit the result of processing carried out in response to a request from the video replay apparatus 6 or information entered through the video replay apparatus 6 to the portable terminal 6. The dummy request can be sent from the portable terminal 6 by executing a control program for controlling the portable terminal 6 to send the dummy request. The control program may be downloaded from the replay control server 2 to the portable terminal 6 and installed in the portable terminal 6. If the portable terminal 6 is equipped with the function for sending the dummy request, then the function of the portable terminal 6 may be used.

In the aforesaid embodiment, the billing information searching means 233 has sent the message indicating that the to-be-viewed content is charged to the video replay apparatus 4. Alternatively, however, the dummy request may be sent from the portable terminal 6 to the replay control server 2, and then the message may be sent to the portable terminal 6.

The aforesaid embodiment has described the case where the communication between the replay control server 2 and the video replay apparatus 4 and the communication between the replay control server 2 and the portable terminal 6 are performed according to the HTTP protocol; however, the present invention is not limited thereto. Any communication protocols may be used according to the specifications of the video replay apparatus 4 and the portable terminal 6.

The entire disclosure of Japanese Patent Application No. 2007-295843 filed on Nov. 14, 2007 including specification, claims, drawings, and summary are incorporated herein by reference in its entirety.

The invention claimed is:

1. A content replay control system configured to be capable of communicating with a content replaying device and a portable terminal installed at a user's end so as to control the replay of a content having a replay restriction set thereon, comprising:
user information storage means for storing a content replaying device ID specific to the content replaying device, a portable terminal ID specific to the portable terminal, and a predetermined URL, in association with each other;
content information storage means for storing a content ID specific to the content and the billing information on the content, in association each other;
means for, upon receipt of a replay request for content to be replayed from the content replaying device, searching the content information storage means for billing information corresponding to the content ID included in the replay request for the content to be replayed, searching the user information storage means for a URL corresponding to the content replaying device ID included in the replay request for the content to be replayed, storing the retrieved billing information in association with the retrieved URL;
means for maintaining the connection with the content replaying device which has transmitted the replay request;
means for, upon acceptance of a request for access to a URL stored in the user information storage means from the portable terminal, reading the billing information stored in association with the URL of the access request and transmitting the read billing information to the portable terminal;
means for, upon receipt of a purchase request for the content to be replayed from the portable terminal, identifying the billing server of a carrier to which the portable terminal belongs on the basis of the portable terminal ID of the portable terminal, and transmitting the billing request on the content to be replayed on the basis of the read billing information to the identified billing server; and
means for transmitting release information for releasing the replay restriction to the content replaying device, the connection of which has been maintained by the connection maintaining means and which has transmitted the replay request, on condition that the billing on the content to be replayed, for which the replay request has been issued, has been completed.

2. The content replay control system according to claim 1, comprising recording means for recording a program executed on the content replaying device in a recording medium in which the content has been recorded,
wherein the program comprises:
a module for, upon receipt of a URL transmitted from the content replay control system, displaying the received URL on a screen;
a module for, upon acceptance of a replay instruction for the content to be replayed from a user, generating a replay request for the content to be replayed, including the content replaying device ID of the content replaying device and transmitting the generated replay request for the content to be replayed to the content replay control system;
a module for maintaining the connection with the content replay control system; and
a module for releasing the replay restriction on the content according to the release information transmitted from the content replay control system.

3. The content replay control system according to claim 2,
wherein the program comprises:
a module for transmitting a dummy request for requesting a result of the processing carried out by the content replay control system according to a processing request transmitted from the portable terminal.

4. The content replay control system according to claim 1, wherein
upon the acceptance of the access request, the means for transmitting the billing information determines whether the URL of the access request and the portable terminal ID included in the access request have been associated and stored in the user information storage means, and in the case where it is determined that the URL of the access request and the portable terminal ID included in the access request have been associated and stored in the user information storage means, transmits the billing information stored in association with the URL of the access request to the portable terminal.

5. The content replay control system according to claim 1, comprising:
means for, upon receipt of a user registration request transmitted from the content replaying device, generating a URL uniquely corresponding to the content replaying device ID included in the user registration request, storing the generated URL and the content replaying device ID in association with each other in the user information storage means, and transmitting the generated URL to the content replaying device; and
means for, upon receipt of a request for access to an URL stored in the user information storage means from the portable terminal, storing a portable terminal ID included in the access request in association with the URL of the access request in the user information storage means in the case where the portable terminal has not been registered.

6. The content replay control system according to claim 1, wherein
the content on which the replay restriction has been set is a content which has been encoded according to a predetermined method, and
the means for transmitting the release information transmits information for decoding the encoded content as release information for releasing the replay restriction from the content.

7. The content replay control system according to claim 1, wherein in the case where the content replaying device has transmitted a dummy request, the means for transmitting billing information transmits the read billing information to the content replaying device as a response to the dummy request.

8. A method executed on a server for controlling the replay of a content recorded in a recording medium replayed by the content replaying device, the server configured to be capable of communicating with the content replaying device and a portable terminal installed at a user's end, the server including a content information storage which stores a content ID specific to a content and the billing information on the content in association each other, and a user information storage which stores a content replaying device ID specific to a content replaying device, a portable terminal ID specific to a portable terminal, and a predetermined URL, in association each other, and
the method comprising:
a step for, upon receipt of a replay request for content to be replayed from the content replaying device, searching the content information storage for the billing information associated with the content ID included in the replay request for the content to be replayed, searching the user information storage for the URL corresponding to the content replaying device ID included in the replay request for the content to be replayed, then storing the retrieved billing information in association with the retrieved URL;
a step for maintaining the connection with the content replaying device which has transmitted the replay request;
a step for, upon acceptance of a request for access to an URL stored in the user information storage from the portable terminal, reading the billing information stored in association with the URL of the access request, and transmitting the read billing information to the portable terminal;
a step for, upon receipt of a purchase request for the content to be replayed from the portable terminal, identifying the billing server of a carrier to which the portable terminal belongs on the basis of the portable terminal ID of the portable terminal, and transmitting a billing request on the content to be replayed based on the read billing information to the identified billing server; and
a step for releasing information for releasing the replay restriction transmitted to the content replaying device, the connection of which has been maintained and which has sent the replay request, on condition that the billing on the content to be replayed, for which the replay request has been issued, has been completed.

9. A method for controlling the replay of content, the method executed on a content replay control system having a content replaying device, a portable terminal, and a server, the method comprising:
a step for, upon acceptance of a replay instruction for content to be replayed from a user, by the content replaying device, generating a replay request for the content to be replayed, which includes a video replaying device ID of the content replaying device, and transmitting the generated replay request for the content to be replayed to the server;
a step for, upon receipt of the replay request of the content to be replayed from the content replaying device, by the server, searching the content information storage, which associates a content ID specific to the content and the billing information on the content and stores the associated information, for the billing information associated with the content ID included in the replay request for the content to be replayed, searching the user information storage, which associates a content replaying device ID specific to the content replaying device, a portable terminal ID specific to the portable terminal, and a predetermined URL and stores all the associated information, for the URL corresponding to the content replaying device ID included in the replay request for the content to be replayed, then storing the retrieved billing information in association with the retrieved URL;
a step for maintaining the connection between the content replaying device and the server;
a step for, upon acceptance of an instruction for access to a URL stored in the user information storage from a user, by the portable terminal, generating a request for access to the URL, which includes the portable terminal ID of the portable terminal and transmitting the generated request for access to the URL to the server;
a step for, upon receipt of a request for access to the URL transmitted from the portable terminal, by the server, transmitting the billing information stored in association with the URL of the access request to the portable terminal;
a step for, upon acceptance of an instruction for purchasing a content to be replayed from a user, by the portable terminal, generating a request for purchasing the content to be replayed and transmitting the generated request for purchasing the content to be replayed to the server;
a step for, upon receipt of the request for purchasing the content to be replayed transmitted from the portable terminal, by the server, identifying the billing server of a carrier to which the portable terminal belongs on the basis of the portable terminal ID of the portable terminal, and transmitting the billing request on the content to be replayed based on the billing information to the identified billing server; and
a step for, by the server, transmitting release information for releasing the replay restriction to the content replaying device, the connection of which has been maintained and which has transmitted the replay request, on condition that the billing on the content to be replayed, for which the replay request has been issued, has been completed.

10. A recording medium in which a content with a replay restriction set thereon and a program to be executed on a content replaying device which replays the content have been recorded,
wherein the program comprises:
a module for displaying, on a screen, a URL received from a predetermined computer;
a module for, upon acceptance of an instruction for replaying a content with the replay restriction set thereon from a user, generating a content replay request which includes the ID of the content replaying device and transmitting the generated content replay request to the predetermined computer;
a maintaining unit for maintaining connection with the predetermined computer;
a module for transmitting a dummy request which requests for receiving a result of the processing carried out by the predetermined computer according to a processing request transmitted from the portable terminal; and
a module for releasing the replay restriction set on the content provided with the restriction on the replay thereof according to release information for releasing the replay restriction transmitted from the predetermined computer as the response to the transmitted dummy request.
